(19) United States
(12) Patent Application Publication
(10) Pub. No.: US 2026/0128790 A1
(43) Pub. Date: May 7, 2026

(54) OPTICAL TRANSMISSION SYSTEM AND QUALITY ESTIMATION METHOD

(71) Applicant: 1FINITY Inc., Kawasaki-shi (JP)

(72) Inventors: Kentaro KAWANISHI, Kawasaki (JP); Hiroki OOI, Kawasaki (JP); Goji NAKAGAWA, Sagamihara (JP)

(73) Assignee: 1FINITY Inc., Kawasaki-shi (JP)

(21) Appl. No.: 19/368,719

(22) Filed: Oct. 24, 2025

(30) Foreign Application Priority Data
Nov. 7, 2024 (JP) 2024-195070

(51) Int. Cl. H04B 10/079

(52) U.S. Cl. CPC H04B 10/07957; H04B 10/07953

(57) ABSTRACT

An optical transmission system includes a first optical transmission device that transmits a first signal light in an actual operation and a first pseudo light having a wavelength different from that of the first signal light, a second optical transmission device that receives the first signal light and the first pseudo light from the first optical transmission device, a measurer that measures a first quality of the first pseudo light between the first optical transmission device and the second optical transmission device, and an estimator that estimates a second quality of the first signal light between the first optical transmission device and the second optical transmission device based on the first quality and an indicator value of wavelength dependence in a signal band.

### CROSS-REFERENCE TO RELATED APPLICATION

This application is based upon and claims the benefit of priority of the prior Japanese Patent Application No. 2024-195070, filed on Nov. 7, 2024, the entire contents of which are incorporated herein by reference.

### FIELD

A certain aspect of embodiments described herein relates to an optical transmission system and a quality estimation method.

### BACKGROUND

A submarine optical communication system is known in which terminal stations transmit and receive wavelength multiplexed optical signals through submarine cables. It is also known to provide a transponder in a terminal station (see, for example, International Publication No. 2021/176923). The wavelength-multiplexed optical signal output from the terminal station of a transmission end includes an optical signal (main signal) on which a data addressed to the terminal station of a reception end is superimposed and a dummy light inserted to compensate for the intensity of the wavelength-multiplexed optical signal according to a presence or absence of the optical signal (see, for example, International Publication No. 2020/158190 and US Patent Application Publication No. 2023/0344541).

The dummy light includes a plurality of lights having an arbitrary center wavelength and an arbitrary bandwidth. The dummy light source that outputs the dummy light includes, for example, an amplified spontaneous emission (ASE) light source and a wavelength selective switch (WSS) (see, for example, International Publication No. 2021/060124). Other than that, it is also known that an indicator of a quality of a signal transmitted in a wavelength division multiplexing (WDM) optical communication system is an optical signal-to-noise ratio (OSNR) (see, for example, US Patent Application Publication No. 2019/0115976).

### SUMMARY

According to an aspect of the embodiments, there is provided an optical transmission system includes a first optical transmission device that transmits a first signal light in an actual operation and a first pseudo light having a wavelength different from that of the first signal light, a second optical transmission device that receives the first signal light and the first pseudo light from the first optical transmission device, a measurer that measures a first quality of the first pseudo light between the first optical transmission device and the second optical transmission device, and an estimator that estimates a second quality of the first signal light between the first optical transmission device and the second optical transmission device based on the first quality and an indicator value of wavelength dependence in a signal band.

According to another aspect of the embodiments, there is provided an optical transmission system includes a first optical transmission device that transmits a first signal light and a second signal light of different wavelengths, both of the first signal light and the second signal light being in actual operation, a second optical transmission device that receives the first signal light and the second signal light, and transmits the first signal light and a first pseudo light having a plurality of wavelengths including the wavelength of the second signal light, a third optical transmission device that receives the first signal light and the first pseudo light from the second optical transmission device, a measurer that measures a first quality of the first pseudo light between the second optical transmission device and the third optical transmission device, and an estimator that estimates a second quality of the first signal light between the first optical transmission device and the third optical transmission device based on the first quality and an indicator value of wavelength dependence in a signal band.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an example of an optical network.

FIG. 2A is an example of a spectrum diagram of the inserted signal light.

FIG. 2B is an example of a spectrum diagram of WDM light.

FIG. 2C is an example of a spectrum diagram of the branched signal light.

FIG. 3 is an example of a circuit configuration of the ROADM.

FIG. 4 is an example of a functional configuration of the controller.

FIG. 5 is an example of an OSNR database.

FIG. 6 is a diagram for explaining an example of correction of the OSNR database.

FIG. 7 is an example of a corrected OSNR database.

FIG. 8 is a diagram for explaining a case #1 during actual operation of the optical network.

FIG. 9 is an example of estimation of the OSNR of signal light in the case #1.

FIG. 10 is another example of estimation of the OSNR of the signal light in the case #1.

FIG. 11 is a diagram for explaining a case #2 during actual operation of the optical network.

FIG. 12 is an example of estimation of the OSNR of signal light in the case #2.

FIG. 13 is another example of estimation of the OSNR of the signal light in the case #2.

FIG. 14 is a diagram for explaining a case #3 during actual operation of the optical network.

FIG. 15 is an example of estimation of the OSNR of signal light in the case #3.

FIG. 16 is another example of estimation of the OSNR of the signal light in the case #3.

FIG. 17 is a flowchart showing an example of the operation of the ROADM.

FIG. 18 is a diagram comparing three comparative examples and an embodiment.

### DESCRIPTION OF EMBODIMENTS

The quality of signal light such as OSNR is sometimes measured by a transponder during actual operation of an optical network. Therefore, when a transponder is provided at a terminal station, the quality of the signal light from one terminal station to another terminal station is measured by the transponder. Between one end station and the other end station, a plurality of transmission nodes such as a reconfigurable optical add/drop multiplexer (ROADM) may be installed. However, even in such a case, there is a problem that the quality of the signal light between terminal stations is only measured and the quality of the signal light between the transmission nodes is not measured for each transmission node during actual operation.

Hereinafter, embodiments for carrying out the present invention will be described with reference to the drawings.

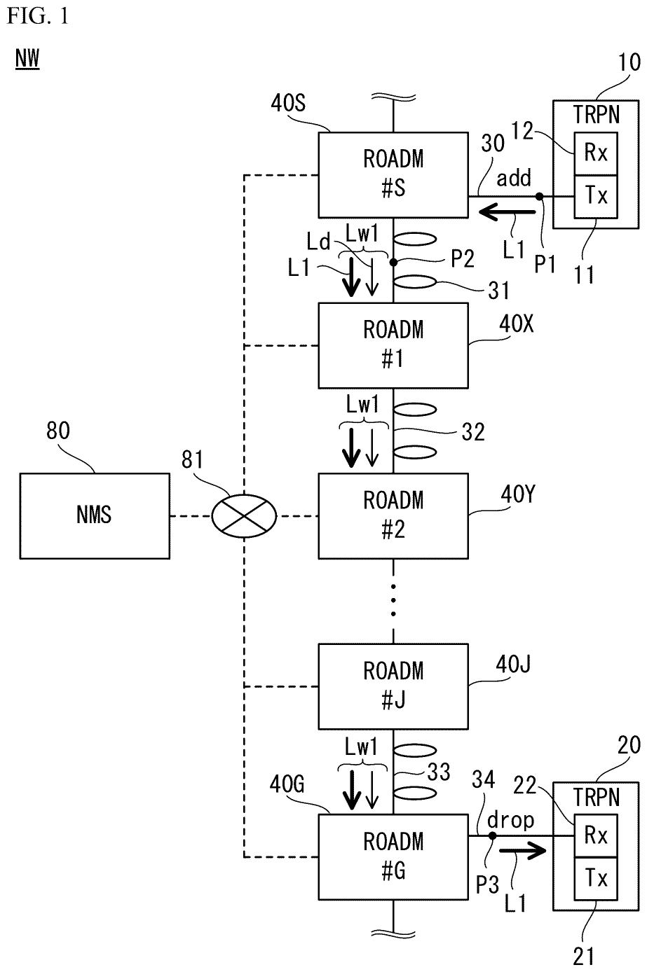

As illustrated in FIG. 1, an optical network NW includes a plurality of transponders (denoted as TRPN in FIG. 1) 10, 20 and a plurality of ROADMs 40S, 40X, 40Y, . . . , 40J, and 40G. The transponders 10, 20 are a transmission/reception node and is provided at the terminal station of the optical network NW.

The ROADMs 40S, 40X, 40Y, . . . , 40J, and 40G are transmission nodes and are provided in non-terminal stations (e.g., relay stations, switching stations, etc.) excluding the terminal stations from the optical network NW. The ROADM 40S is an example of the first optical transmission device. At least one of the ROADMs 40X, 40Y, . . . , 40J is an example of the second optical transmission device. The ROADM 40G is an example of the third optical transmission device. At least one of the ROADMs 40X, 40Y, . . . , 40J may be the third optical transmission device, and the ROADM 40G may be the second optical transmission device.

The transponder 10 and the ROADM 40S are connected to each other by a transmission line 30. The ROADMs 40S and 40X are connected to each other through a transmission line 31. The ROADMs 40X and 40Y are connected to each other by a transmission line 32. The ROADMs 40J and 40G are connected to each other through a transmission line 33. The ROADM 40G and the transponder 20 are connected to each other by a transmission line 34.

Each of the transmission lines 30, 31, 32, 33 and 34 and includes an optical fiber. A relay node such as an optical in-line amplifier equipment (ILA) may be installed in a middle of each of the transmission lines 31, 32, 33. The ROADMs 40Y and 40J are connected in the same manner as the ROADMs 40S and 40X, but are omitted in FIG. 1. One or a plurality of ROADMs and ILAs (neither of which is illustrated) may be installed between the ROADMs 40Y and 40J via a transmission line.

The transponder 10 includes an optical transmitter 11 (denoted as Tx in FIG. 1) and an optical receiver 12 (denoted as Rx in FIG. 1). The transponder 20 includes an optical transmitter 21 and an optical receiver 22. The optical transmitter 11 transmits the signal light L1. The signal light L1 is input to the transmission line 30, propagates through the transmission line 30, and reaches the ROADM 40S.

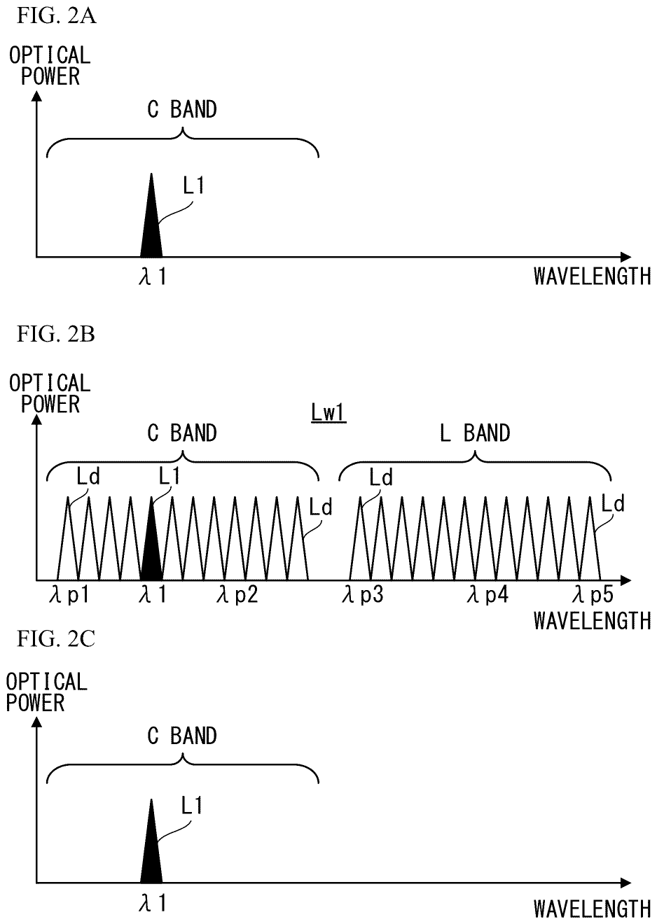

For example, when optical power of the signal light L1 having the wavelength λ1 belonging to a conventional-band (C-band) is measured at a first measurement point P1 on the transmission line 30, the optical power of the signal light L1 having the wavelength λ1 appears independently in the spectrum diagram as illustrated in FIG. 2A.

As illustrated in FIG. 1, the ROADM 40S outputs a WDM light Lw1 obtained by multiplexing the signal light L1 and a dummy light (a pseudo light) Ld. In the ROADM 40S, as illustrated in FIG. 2B, not only the dummy light Ld having the wavelengths λp1, λp2, etc. belonging to the C band but also the dummy light Ld having the wavelengths λp3, λp4, λp5, etc. belonging to a Long-wavelength-band (L band) are multiplexed. In the ROADM 40S, the signal light L1 is inserted (added) into the wavelength λ1 that is empty among these dummy lights Ld. In this embodiment, the ROADM 40S which inserts the signal light L1 corresponds to a start point of the signal light L1.

As illustrated in FIG. 1, the WDM light Lw1 output from the ROADM 40S is input to the transmission line 31, propagates through the transmission line 31, and reaches a first ROADM 40X installed next to the ROADM 40S. Therefore, when the optical power of the WDM light Lw1 is measured at a second measurement point P2 on the transmission line 31, the optical power of the signal light L1 having the wavelength λ1 and the optical power of the dummy light Ld having the wavelengths λp1, λp2, λp3, λp4, λp5, etc. appear in the spectrum diagram as illustrated in FIG. 2B. In this way, the dummy light Ld fills an empty band excluding the wavelength λ1 of the signal light L1 in signal bands such as the C band and the L band used in the actual operation of the optical network NW.

As illustrated in FIG. 1, the ROADM 40X transfers the WDM light Lw1 from the ROADM 40S to the ROADM 40Y provided second. Similarly, the ROADM 40Y transfers the WDM light Lw1 from the ROADM 40S to the J-th ROADM 40J. The ROADM 40J transfers the WDM light Lw1 to the ROADM 40G.

The ROADM 40G demultiplexes the signal light L1 from the WDM light Lw1 and outputs the signal light L1 to the transmission line 34. The signal light L1 propagates through the transmission line 34 and reaches the transponder 20. Thus, the optical receiver 22 of the transponder 20 receives the signal light L1. In the present embodiment, the ROADM 40G which branches (drops) the signal light L1 from the WDM light Lw1 corresponds to a goal point of the signal light L1. When the optical power of the signal light L1 having the wavelength λ1 is measured at a third measurement point P3 on the transmission line 34, the optical power of the signal light L1 having the wavelength λ1 appears independently in the spectrum diagram as illustrated in FIG. 2C.

Each of the ROADMs 40S, 40X, 40Y, . . . , 40J, and 40G is electrically connected to a network management system (NMS) 80. The NMS 80 controls the operation of the ROADM 40S and the like via a communication network 81 such as a local area network (LAN) or an Internet. The NMS 80 includes an optical network controller, and can control the operation of the ROADM 40S and the like by the optical network controller. The NMS 80 or optical network controller is an example of a control device. As will be described in detail later, the NMS 80 manages an wavelength arrangement and various measured values of the signal light L1 and the dummy light Ld, and estimates the OSNR of the signal light L1 as the quality of the signal light L1 based on the wavelength arrangement and the various measured values.

The optical transmission system may be realized by the ROADMs 40S, 40X, 40Y, . . . , 40J, 40G excluding the NMS 80, or by the NMS 80 and the ROADMs 40S, 40X, 40Y, . . . , 40J, 40G.

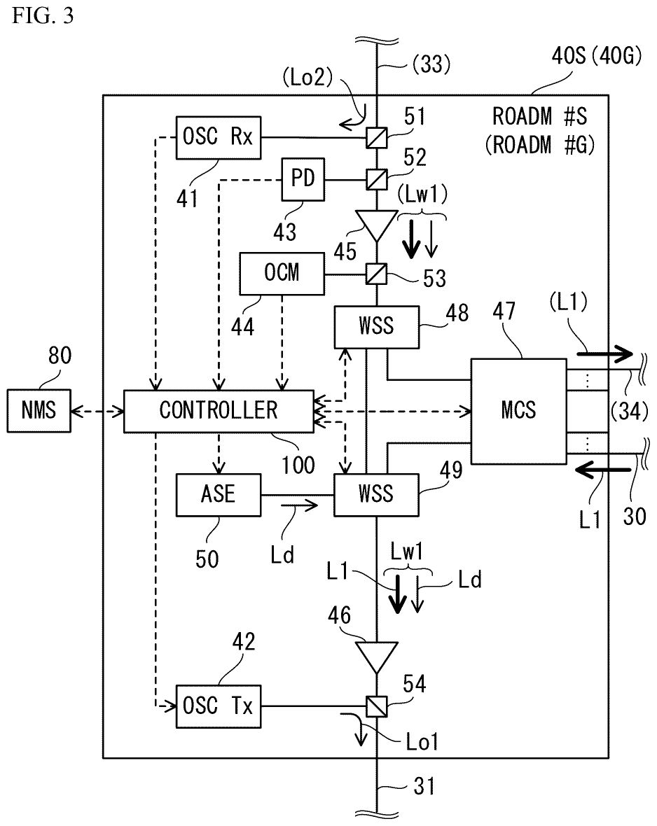

Referring to FIG. 3, a circuit configuration of the ROADM 40S will be described. The ROADMs 40X, 40Y, . . . , 40J and 40G have basically the circuit configuration same as the ROADM 40S, and therefore, detailed description thereof will be omitted. In FIG. 3, the reference numerals required for the description of the ROADM 40G are illustrated in parentheses.

The ROADM 40S includes an optical supervisory channel (OSC) light receiver 41 (abbreviated as OSC Rx in FIG. 3), an OSC light transmitter 42 (abbreviated as OSC Tx in FIG. 3), and a photo diode (PD) 43. The ROADM 40S includes an optical channel monitor (OCM) 44, optical amplifiers 45 and 46, and a multicast switch (MCS) 47. The ROADM 40S also includes wavelength selective switches (WSSs) 48 and 49, an amplified spontaneous emission (ASE) light source 50 (simply abbreviated as ASE in FIG. 3), and a controller 100. The controller 100 will be described in detail later.

The OSC light transmitter 42 transmits the OSC light Lo1 based on an instruction from the controller 100. The OSC light Lo1 is output to the transmission line 31 through a WDM coupler 54. That is, the ROADM 40S outputs the OSC light Lo1 to the transmission line 31. The transmission line 31 is connected to the ROADM 40X (see FIG. 1). Therefore, the OSC light Lo1 reaches the ROADM 40X.

Similarly, the OSC light Lo2 output from the ROADM 40J reaches the ROADM 40G through the transmission line 33. The OSC light receiver 41 receives the OSC light Lo2 through a branch coupler 51. Upon receiving the OSC light Lo2, the OSC light receiver 41 measures the optical power of the received OSC light Lo2 and notifies the controller 100 of the measured value.

The PD 43 detects the WDM light Lw1 output from the ROADM 40J and branched by a branch coupler 52. The branch coupler 52 is disposed in a front stage or upstream of the optical amplifier 45. Thus, the PD 43 can detect the WDM light Lw1 that has been input to the ROADM 40G and has not yet been input to the optical amplifier 45. When the WDM light Lw1 is detected, the PD 43 notifies the controller 100 of the detection value of the WDM light Lw1.

The OCM 44 measures the optical power of the WDM light Lw1 output from the ROADM 40J and branched by a branch coupler 53 for each wavelength. The branch coupler 53 is disposed in a rear stage or downstream of the optical amplifier 45. Thus, the OCM 44 can measure the optical power of the WDM light Lw1 after passing through the optical amplifier 45 for each wavelength. That is, the OCM 44 can measure the optical power of the signal light L1 and the optical power of the dummy light Ld for each wavelength. When the OCM 44 measures the optical powers of the signal light L1 and the dummy light Ld, the OCM 44 notifies the controller 100 of the measured values of the dummy light Ld.

The optical amplifier 45 amplifies the optical power of the WDM light Lw1 output from the ROADM 40J and input to the ROADM 40G. The optical amplifier 46 amplifies the optical power of the WDM light Lw1 output from the ROADM 40S to the ROADM 40X.

When the signal light L1 is input, the MCS 47 detects the wavelength λ1 of the signal light L1 and notifies the controller 100 of the wavelength 21. When the signal light L1 is input, the MCS 47 selects a degree for outputting the signal light L1 based on an instruction from the controller 100, and outputs the signal light L1 to a selected degree. For example, when the signal light L1 transmitted from the optical transmitter 11 and propagated through the transmission line 30 is input to the MCS 47, the MCS 47 selects the WSS 49 among the WSSs 48 and 49 optically connected to the MCS 47. When the signal light L1 output from the WSS 48 is input, the MCS 47 selects the transmission line 34 optically connected to the optical receiver 22.

The WSS 48 includes a demultiplexer that demultiplexes the WDM light Lw1 for each wavelength. When the WDM light Lw1 is input, the WSS 48 demultiplexes the WDM light Lw1 for each wavelength and outputs the signal light L1 included in the WDM light Lw1 to the MCS 47 based on an instruction from the controller 100. The WSS 48 can block a passage of the dummy light Ld included in the WDM light Lw1.

The WSS 49 includes a multiplexer that multiplexes the signal light L1 and the dummy light Ld. When the signal light L1 is input, the WSS 49 outputs the WDM light Lw1 obtained by multiplexing the signal light L1 and the dummy light Ld to the optical amplifier 46 based on an instruction from the controller 100. The ASE light source 50 switches between light emission and light emission stop based on an instruction from the controller 100, and outputs dummy light Ld having a wavelength excluding the wavelength λ1 of the signal light L1 at the time of light emission, for example. The dummy light Ld output from the ASE light source 50 is input to the WSS 49. Thus, the WSS 49 can output the WDM light Lw1 obtained by multiplexing the signal light L1 and the dummy light Ld.

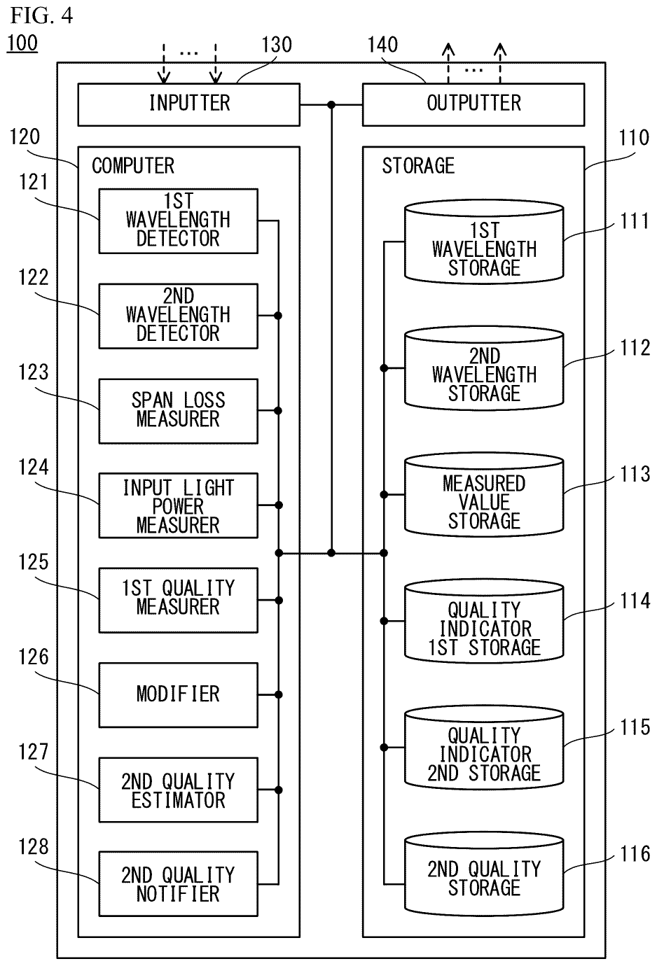

Referring to FIGS. 4 to 7, a hardware configuration and the functional configuration of the controller 100 will be described.

The controller 100 is implemented by, for example, a processor such as a central processing unit (CPU) and a memory such as a random-access memory (RAM) or a read only memory (ROM). The RAM temporarily stores a control program stored in the ROM by the CPU. The CPU executes a stored control program to realize various functions described later. The control program may be one corresponding to a flowchart described later. The controller 100 may be implemented by a hardware circuit such as a field programmable gate array (FPGA) or an application specific integrated circuit (ASIC).

As illustrated in FIG. 4, the controller 100 includes a storage 110, a computer 120, an inputter 130, and an outputter 140. The storage 110 can be realized by the above-described memory. The computer 120 can be implemented by the processor described above. The inputter 130 and the outputter 140 can be implemented by a communication I/F (interface).

The storage 110, the computer 120, the inputter 130, and the outputter 140 are connected to each other. The storage 110 includes a first wavelength storage 111, a second wavelength storage 112, a measured value storage 113, a quality indicator first storage 114, a quality indicator second storage 115, and a second quality storage 116. The computer 120 includes a first wavelength detector 121, a second wavelength detector 122, a span loss measurer 123, and an input light power measurer 124. The computer 120 includes a first quality measurer 125, a modifier 126, a second quality estimator 127, and a second quality notifier 128. The span loss measurer 123, the input optical power measurer 124, and the first quality measurer 125 are examples of measurers. The second quality estimator 127 is an example of an estimator.

The first wavelength detector 121 detects the wavelength 21 of the signal light L1 to be inserted, which is input to the WSS 49 (see FIG. 3), and the wavelengths λp1, . . . , λp5 of the dummy light Ld accompanying the signal light L1 to be inserted. When the first wavelength detector 121 detects the wavelength λ1, the wavelength λp1, . . . , the wavelength λp5, and the like, the first wavelength detector 121 stores the wavelength 21, the wavelength λp1, . . . , the wavelength λp5, and the like in the first wavelength storage 111.

The first wavelength storage 111 stores the wavelength 21 and the wavelengths λp1, . . . , λp5, etc. as post wavelength data in association with each other. The NMS 80 periodically or non-periodically accesses the first wavelength storage 111 to acquire post wavelength data. Upon acquisition of the post wavelength data, the NMS 80 manages the post wavelength data.

The second wavelength detector 122 detects the wavelength 21 of the signal light L1 to be branched included in the WDM light Lw1 input to the WSS 48 (see FIG. 3) and the wavelengths λp1, . . . , λp5 of the dummy light Ld included in the WDM light Lw1. When the second wavelength detector 122 detects the wavelength 21, the wavelength λp1, . . . , the wavelength λp5, and the like, the second wavelength detector 122 stores the wavelength 21, the wavelength λp1, . . . , the wavelength λp5, and the like in the second wavelength storage 112.

The second wavelength storage 112 stores the wavelength λ1 and the wavelengths λp1, . . . , λp5, etc. as pre-wavelength data in association with each other. The NMS 80 periodically or non-periodically accesses the second wavelength storage 112 to acquire pre-wavelength data. Upon acquiring the pre-wavelength data, the NMS 80 manages the pre-wavelength data.

The span loss measurer 123 measures the span loss between the ROADMs 40S and 40G based on a set value of the optical power of the OSC light Lo2 transmitted by the OSC light transmitter 42 and a measured value of the optical power of the OSC light Lo2 notified from the OSC light receiver 41. When the span loss is measured, the span loss measurer 123 stores the measured value of the span loss in the measured value storage 113.

The input light power measurer 124 measures an input light power of the WDM light Lw1 input to the optical amplifier 45 based on a detected value of the WDM light Lw1 notified from the PD 43. When the input light power is measured, the input light power measurer 124 stores the measured value of the input light power in the measured value storage 113.

The first quality measurer 125 measures the OSNR of the dummy light Ld as the quality of the dummy light Ld on the basis of the measured value of the optical power by the OCM 44 when the dummy light Ld is emitted and the measured value of the optical power by the OCM 44 when the dummy light Ld is stopped being emitted. That is, the OSNR of the dummy light Ld is an example of a first quality. When the first quality measurer 125 measures the OSNR of the dummy light Ld, the first quality measurer 125 stores the measured value of the OSNR in the measured value storage 113.

Thus, the measured value storage 113 stores the measured value of the span loss, the measured value of the input optical power, and the measured value of the OSNR of the dummy light Ld as measured data. The NMS 80 periodically or non-periodically accesses the measured value storage 113 to acquire measured data. When the NMS 80 acquires the measured data, the NMS 80 manages the measured data.

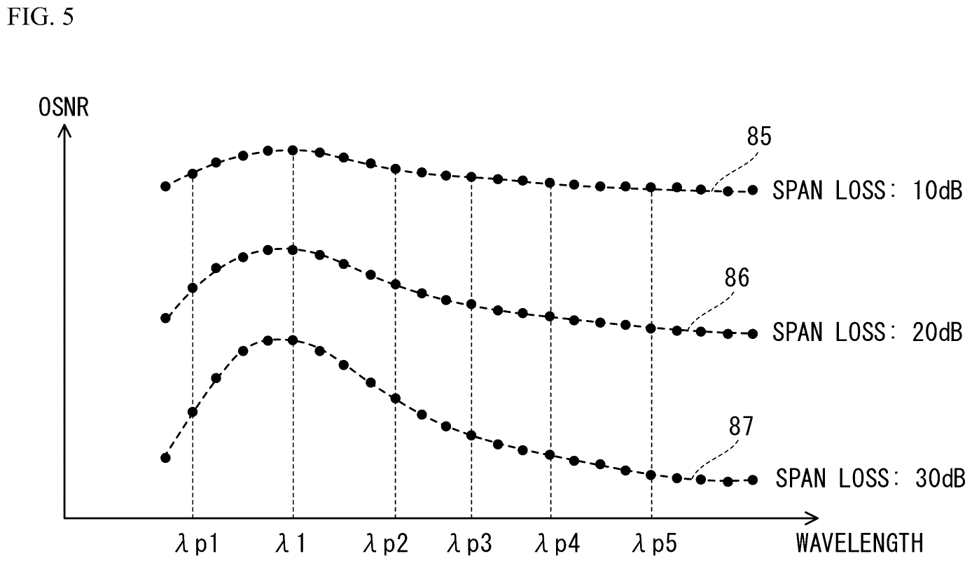

The quality indicator first storage 114 stores an OSNR database. The OSNR database is created in advance (before shipment or before operation, for example). The OSNR database may be created before the operation of the optical communication service performed between the ROADMs 40S and 40G based on the signal light L1 is started. As illustrated in FIG. 5, in the OSNR database, wavelength-dependent OSNR indicator values in signal bands such as the C band and the L band are recorded for each span loss in all wavelengths including the wavelength λ1 of the signal light L1 and the wavelengths λp1, . . . , λp5 of the dummy light Ld. In FIG. 5, as an example, a first OSNR indicator value 85 having a span loss of 10 dB, a second OSNR indicator value 86 having a span loss of 20 dB, and a third OSNR indicator value 87 having a span loss of 30 dB are illustrated. The number of OSNR indicator values may be increased or decreased by changing the unit interval of span loss, which is 10 dB.

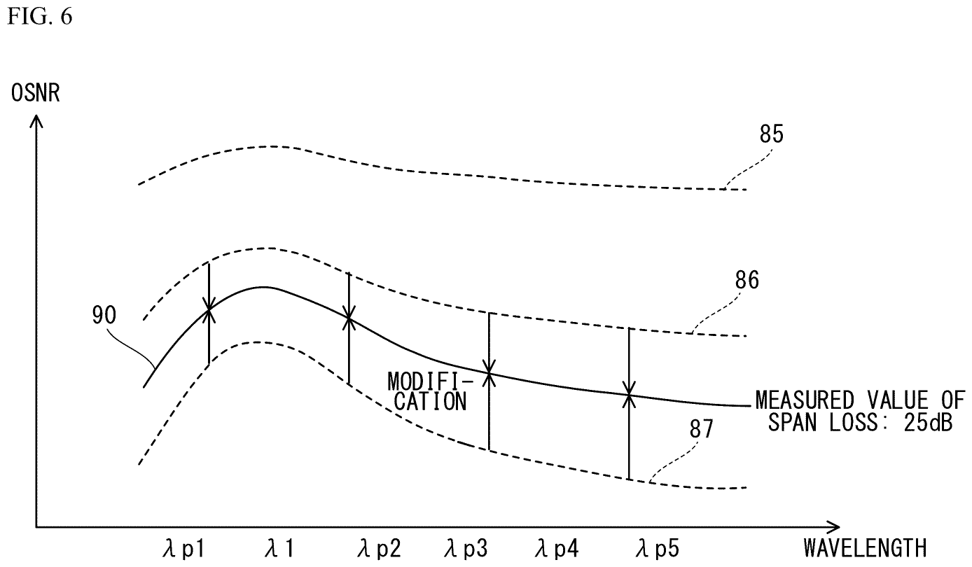

The modifier 126 modifies the OSNR database based on the measured value of the span loss stored in the measured value storage 113. For example, as illustrated in FIG. 6, when the measured value storage 113 stores 25 dB as the measured value of the span loss, the modifier 126 modifies the second OSNR indicator value 86 and the third OSNR indicator value 87 to a new OSNR indicator value 90 based on this measured value. The modifier 126 may modify both the second OSNR indicator value 86 and the third OSNR indicator value 87, or may modify either one of them.

For example, the modifier 126 can generate the new OSNR indicator value 90 having a span loss of 25 dB by calculating an average value of the second OSNR indicator value 86 having a span loss of 20 dB and the third OSNR indicator value 87 having a span loss of 30 dB. When the measured value of the span loss is 22 dB or 28 dB, the modifier 126 may change a modification ratio of the second OSNR indicator value 86 and the third OSNR indicator value 87 based on these measured values.

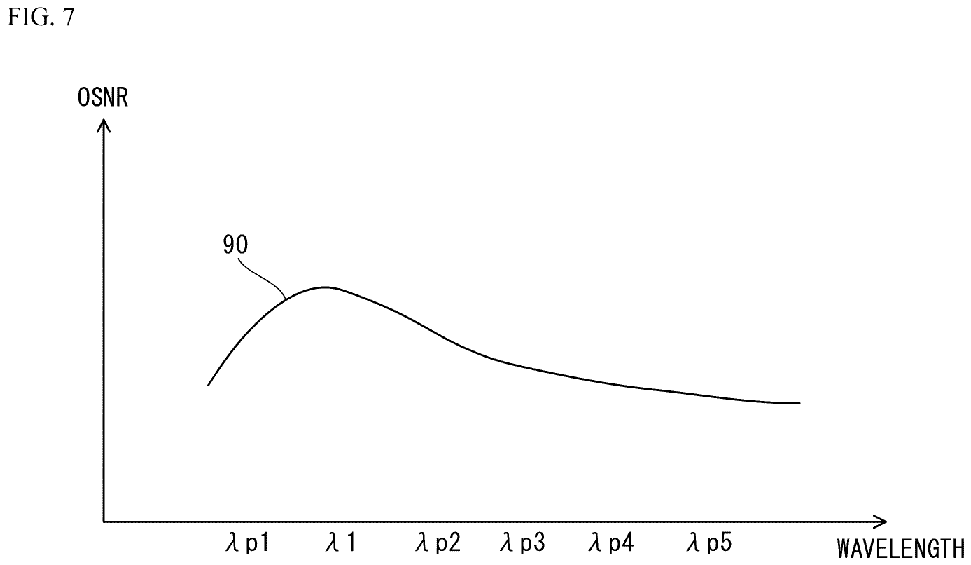

After modifying the OSNR database, the modifier 126 stores the new OSNR indicator value 90 in the quality indicator second storage 115. As a result, as illustrated in FIG. 7, the quality indicator second storage 115 stores the modified OSNR database in which the new OSNR indicator value 90 is recorded. The NMS 80 periodically or non-periodically accesses the quality indicator second storage 115 to acquire the modified OSNR database. Upon acquiring the modified OSNR database, the NMS 80 manages the modified OSNR database.

The second quality estimator 127 estimates the OSNR of the signal light L1. The OSNR of the signal light L1 is an example of a second quality. For example, the second quality estimator 127 estimates the OSNR of the signal light L1 between the ROADMs 40S and 40G based on the measured value of the OSNR of the dummy light Ld managed as the measured data by the NMS 80 and the new OSNR indicator value 90. The second quality estimator 127 can acquire the measured value of the OSNR of the dummy light Ld from the NMS 80 through the inputter 130 and the outputter 140. The second quality estimator 127 can also acquire the new OSNR indicator value 90 from the quality indicator second storage 115. After estimating the OSNR of the signal light L1, the second quality estimator 127 stores the estimated value of the OSNR of the signal light L1 in the second quality storage 116. The details of the process of estimating the OSNR of the signal light L1 will be described later.

The second quality notifier 128 notifies the estimated value of the OSNR of the signal light L1 to a terminal of a business operator (hereinafter referred to as a business operator terminal) that requests the OSNR of the signal light L1 during the actual operation of the optical network NW. Some carriers (e.g., communication common carriers) operating the optical network NW may desire to confirm the failure portions and the signs of failure of the ROADMs 40S, . . . , 40G. In this case, the notification of the OSNR of the signal light L1 is requested from the operator terminal to the second quality notifier 128.

When the notification of the OSNR of the signal light L1 is requested, the second quality notifier accesses the second quality storage 116, acquires the estimated value of the OSNR of the signal light L1, and notifies the estimated value of the OSNR of the signal light L1 to the operator terminal through the outputter 140. Thus, the estimated value of the OSNR of the signal light L1 is output on the screen of the business operator terminal, for example.

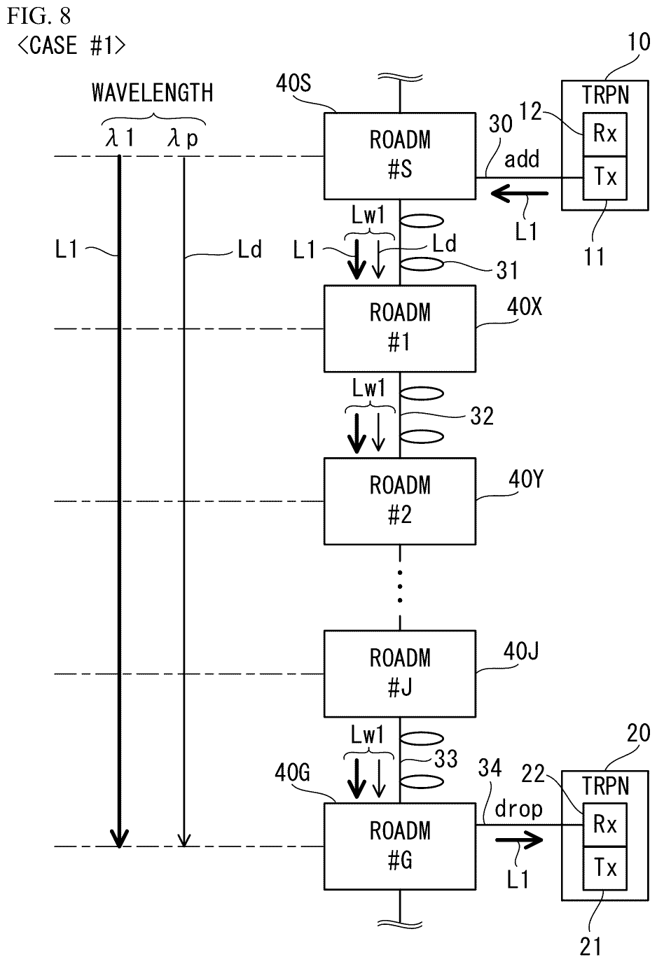

Referring to FIGS. 8 to 16, three cases in which the OSNR of the signal light L1 is estimated by the ROADM 40G will be individually described. The ROADM 40G can access the NMS 80 to acquire the post-wavelength data, the pre-wavelength data, the measured data, and the modified OSNR database managed by the NMS 80.

First, referring to FIGS. 8 to 10, the case #1 will be described. In the case #1, as illustrated in FIG. 8, the dummy light Ld having the wavelength λp including the wavelengths λp1, . . . , λp5 is translated from the ROADM40S to the ROADM40G with respect to the signal light L1 having the wavelength 21.

In the case #1, the second quality estimator 127 acquires the measured value of the OSNR of the dummy light Ld of the wavelength λp measured by the ROADM 40G and the modified OSNR database from the NMS 80. The second quality estimator 127 may acquire the measured value of the OSNR of the dummy light Ld having the wavelength λp from the measured value storage 113. The second quality estimator 127 may acquire the modified OSNR database from the quality indicator second storage 115.

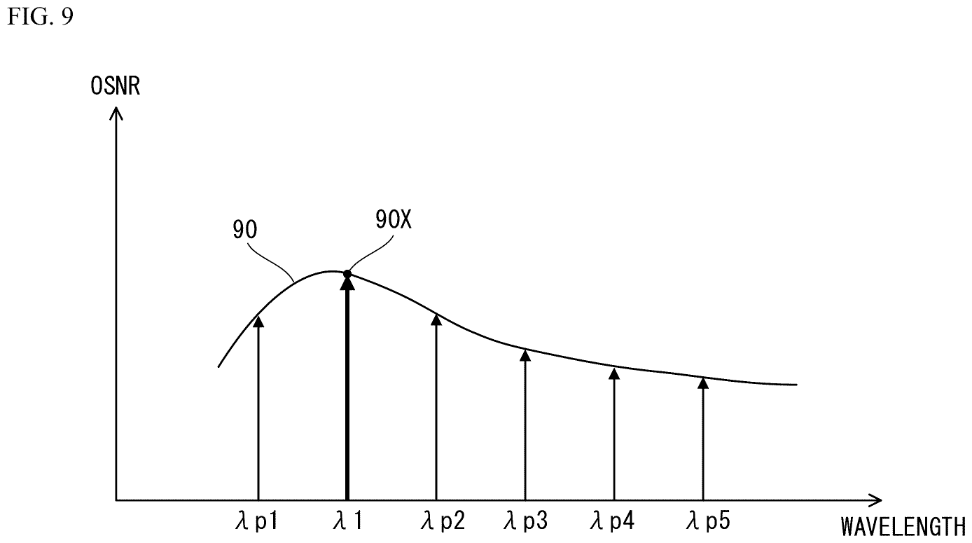

When the second quality estimator 127 acquires the measured value of the OSNR of the dummy light Ld of the wavelength λp and the modified OSNR database, the second quality estimator 127 matches the measured value of each OSNR of the wavelengths λp1, . . . , λp5 included in the wavelength λp with the new OSNR indicator value 90 included in the modified OSNR database, as illustrated in FIG. 9. Since the new OSNR indicator value 90 is generated based on the dummy light Ld of the wavelength λp and the span loss, each measured value of OSNR is likely to match the new OSNR indicator value 90. Therefore, the second quality estimator 127 estimates a corresponding value 90X on the new OSNR indicator value 90 corresponding to the wavelength λ1 as the OSNR of the signal light L1.

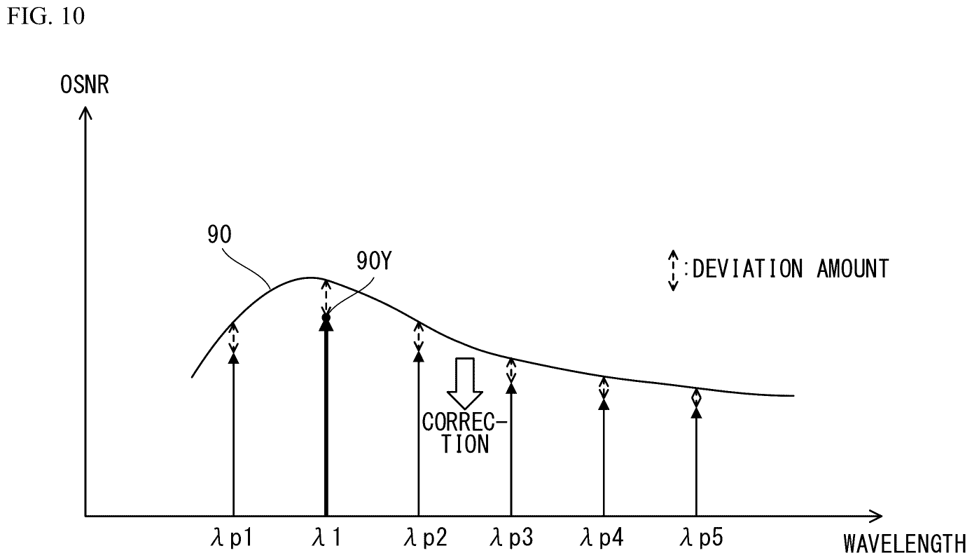

As illustrated in FIG. 10, there is a case where the measured values of the OSNRs of the wavelengths λp1, . . . , λp5 do not match the new OSNR indicator value 90. In this case, the second quality estimator 127 may individually calculate the amount of deviation between each OSNR and the new OSNR indicator value 90, and estimate the OSNR of the signal light L1 based on the new OSNR indicator value 90 and the amount of deviation. For example, the second quality estimator 127 corrects the new OSNR indicator value 90 to match each OSNR based on the individually calculated deviation amount. When the new OSNR indicator value 90 is corrected, the second quality estimator 127 estimates a corresponding value 90Y of the corrected new OSNR indicator value (not illustrated) corresponding to the wavelength λ1 as the OSNR of the signal light L1.

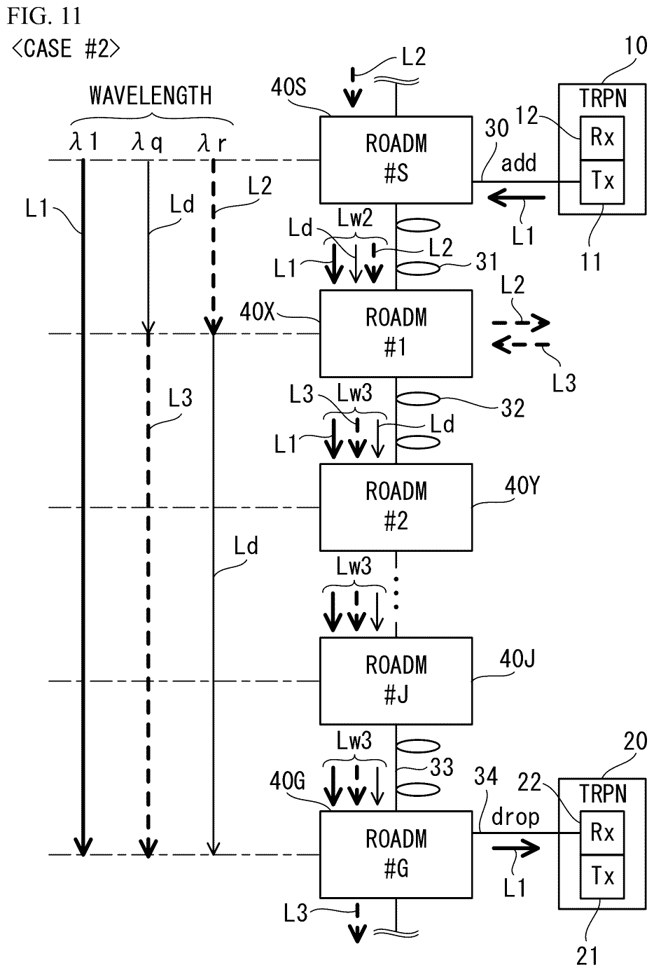

Next, referring to FIGS. 11 to 13, the case #2 will be described. As illustrated in FIG. 11, the case #2 is a case where the dummy light Ld of the wavelength λq including the wavelengths λq1, . . . , λq5 and the dummy light Ld of the wavelength λr including the wavelengths λr1, . . . , λr5 are translated from the ROADM 40S to the ROADM 40G with an interruption therebetween, with respect to the signal light L1 of the wavelength λ1.

More specifically, the signal light L2 having the wavelength λr is input to the ROADM 40S from the upstream side of the ROADM 40S. Thus, the ROADM 40S transmits the WDM light Lw2 obtained by multiplexing the signal light L1 of the wavelength λ1, the signal light L2 of the wavelength λr, and the dummy light Ld of the wavelength Aq. In the ROADM 40X, the signal light L2 included in the WDM light Lw2 is branched and the signal light L3 having the wavelength λq is inserted. Thus, the ROADM 40X transmits the WDM light Lw3 obtained by multiplexing the signal light L1 of the wavelength λ1, the signal light L3 of the wavelength λq, and the dummy light Ld of the wavelength λr. In the ROADM 40G, the signal light L1 included in the WDM light Lw3 is branched, and the signal light L3 is excluded from the branching target. The ROADM 40G outputs the signal light L3 downstream of the ROADM 40G.

In the case #2, the second quality estimator 127 acquires, from the NMS 80, the measured value of the OSNR of the dummy light Ld of the wavelength λr measured by the ROADM 40G as a first measured value. The second quality estimator 127 acquires, from the NMS 80, the measured value of the OSNR of the dummy light Ld of the wavelength λq measured by the ROADM 40G as a second measured value. Furthermore, the second quality estimator 127 acquires the modified OSNR database from the NMS 80.

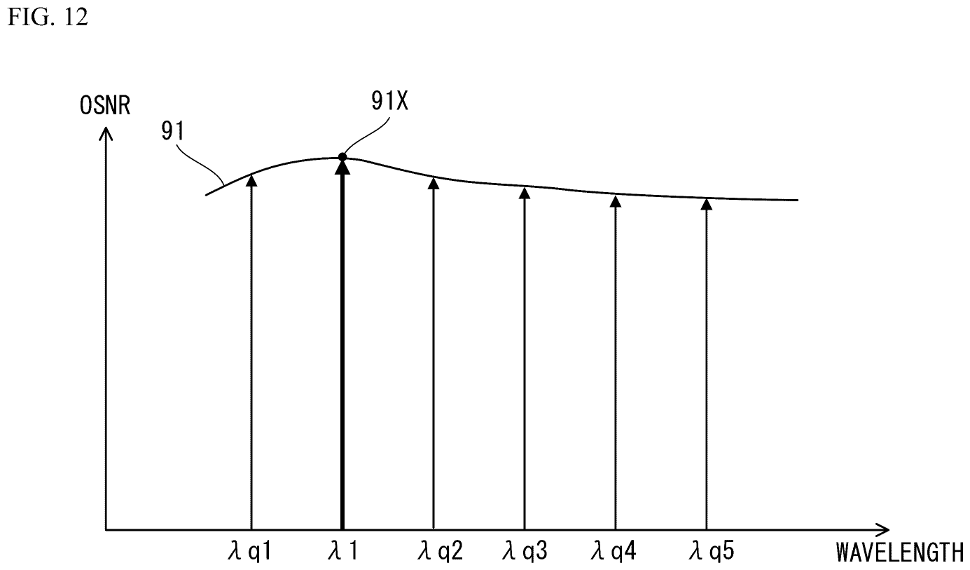

When the second quality estimator 127 acquires the first measured value, the second measured value, and the modified OSNR database, the second quality estimator 127 matches the measured values of the OSNRs of the wavelengths λq1, . . . , λq5 included in the wavelength λq with a new OSNR indicator value 91 included in the modified OSNR database, as illustrated in FIG. 12. Since the new OSNR indicator value 91 is generated based on the dummy light Ld of the wavelength λq and the span loss, each measured value of OSNR is likely to match the new OSNR indicator value 91. Therefore, the second quality estimator 127 estimates a corresponding value 91X on the new OSNR indicator value 91 corresponding to the wavelength λ1 as a part of the OSNR of the signal light L1.

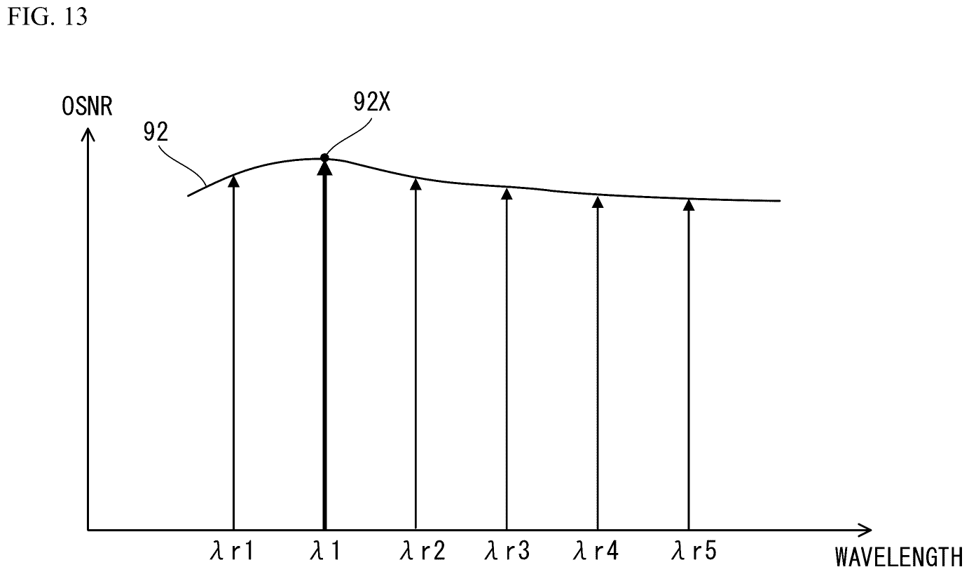

When the second quality estimator 127 acquires the first measured value, the second measured value, and the modified OSNR database, the second quality estimator 127 matches the measured values of the OSNRs of the wavelengths λr1, . . . , λr5 included in the wavelength λr with a new OSNR indicator value 92, as illustrated in FIG. 13. Since the new OSNR indicator value 92 is generated based on the dummy light Ld of the wavelength λr and the span loss, each measured value of OSNR is likely to match the new OSNR indicator value 92. Therefore, the second quality estimator 127 estimates a corresponding value 92X on the new OSNR indicator value 92 corresponding to the wavelength λ1 as a residual part of the OSNR of the signal light L1.

The second quality estimator 127 estimates the part of the OSNR of the signal light L1 and the residual part of the OSNR of the signal light L1, and then sums the part of the OSNR and the residual part of the OSNR based on the following Formula (1) to estimate an overall OSNR of the signal light L1 having the wavelength λ1.

$$1 / OSNR ( Total ) = \{ 1 / OSNR ( the part ) \} + \{ 1 / OSNR ( the residual part ) \} \qquad Formula ( 1 )$$

Thus, even in the case #2, the ROADM 40G can estimate the overall OSNR of the signal light L1 having the wavelength λ1. In the case where the measured values of the OSNRs do not match the new OSNR indicator value 91 or do not match the new OSNR indicator value 92, the second quality estimator 127 can apply the amount of deviation described in the case #1.

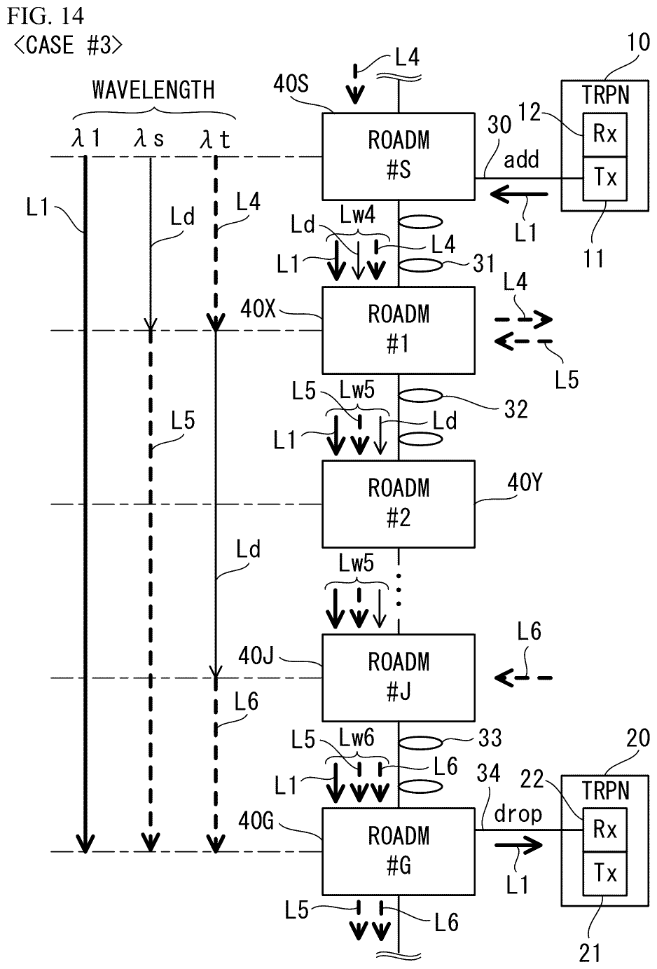

Next, referring to FIGS. 14 to 16, the case #3 will be described. As illustrated in FIG. 14, the case #3 is a case where the dummy light Ld having the wavelength λs including the wavelengths λs1, . . . , λs5 and the dummy light Ld having the wavelength λt including the wavelengths λt1, . . . , λt5 do not translate from the ROADM 40S to the ROADM 40G while interrupting the signal light L1 having the wavelength λ1.

More specifically, the signal light L4 having the wavelength λt is input to the ROADM 40S from the upstream side of the ROADM 40S. Thus, the ROADM 40S transmits the WDM light Lw4 obtained by multiplexing the signal light L1 of the wavelength λ1, the signal light L4 of the wavelength λt, and the dummy light Ld of the wavelength λs. In the ROADM 40X, the signal light L4 included in the WDM light Lw4 is branched and the signal light L5 having the wavelength λs is inserted. Thus, the ROADM 40X transmits the WDM light Lw5 obtained by multiplexing the signal light L1 of the wavelength λ1, the signal light L5 of the wavelength λs, and the dummy light Ld of the wavelength λt.

In the ROADM 40J, the signal light L6 having the wavelength λt is inserted. Thus, the ROADM 40J transmits the WDM light Lw6 obtained by multiplexing the signal light L1 of the wavelength λ1, the signal light L5 of the wavelength λs, and the signal light L6 of the wavelength λt. In the ROADM 40G, the signal light L1 included in the WDM light Lw6 is branched, and the signal lights L5 and L6 are excluded from the branching target. The ROADM 40G outputs the signal lights L5 and L6 downstream of the ROADM40G.

In the case #3, the second quality estimator 127 acquires the measured value of the OSNR of the dummy light Ld of the wavelength λs measured by the ROADM 40X from the NMS 80 as the third measured value. The second quality estimator 127 acquires, from the NMS 80, the measured value of the OSNR of the dummy light Ld having the wavelength λt measured by the ROADM 40J as a fourth measured value. Further, the second quality estimator 127 acquires the measured value of the input optical power from the NMS 80 as a fifth measured value. In addition, the second quality estimator 127 acquires the modified OSNR database from the NMS 80.

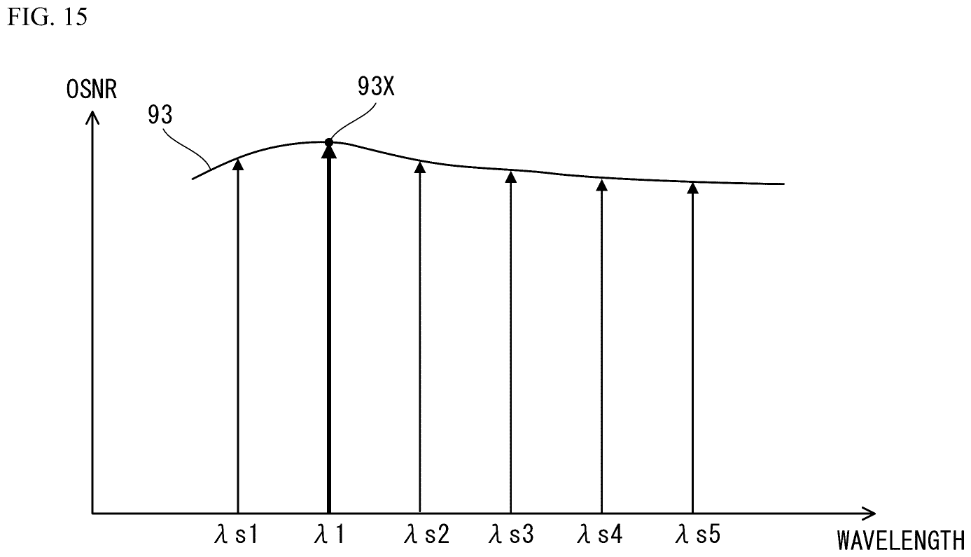

When the second quality estimator 127 acquires the third measured value, the fourth measured value, the fifth measured value, and the modified OSNR database, the second quality estimator 127 matches the measured values of the OSNRs of the wavelengths λs1, . . . , λs5 included in the wavelength λs with a new OSNR indicator value 93 included in the modified OSNR database, as illustrated in FIG. 15. Since the new OSNR indicator value 93 is generated based on the dummy light Ld of the wavelength λs and the span loss, each measured value of OSNR is likely to match the new OSNR indicator value 93. Therefore, the second quality estimator 127 estimates a corresponding value 93X on the new OSNR indicator value 93 corresponding to the wavelength λ1 as the first estimated value of the OSNR of the signal light L1.

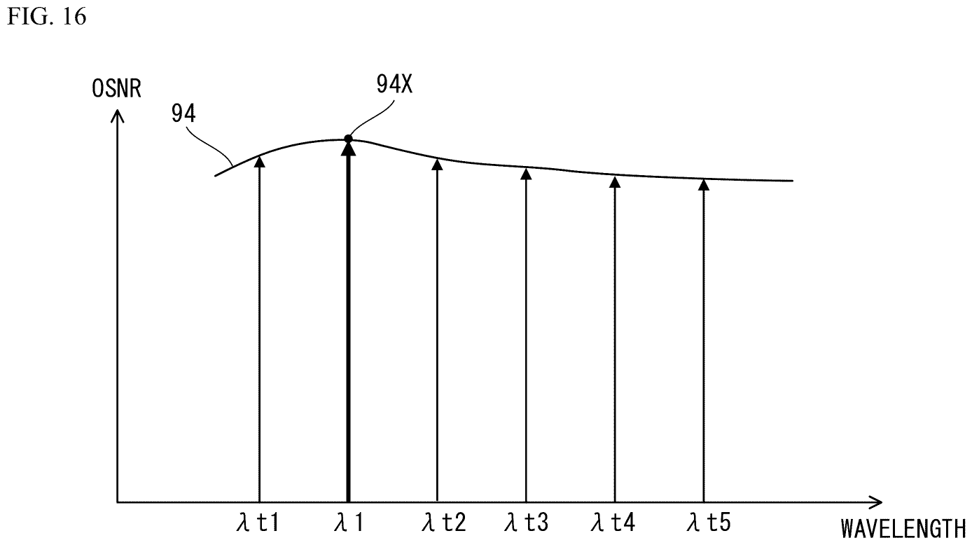

When the second quality estimator 127 acquires the third measured value, the fourth measured value, the fifth measured value, and the modified OSNR database, the second quality estimator 127 matches the measured values of the OSNRs of the wavelengths λt1, . . . , λt5 included in the wavelength λt with a new OSNR indicator value 94, as illustrated in FIG. 16. Since the new OSNR indicator value 94 is generated based on the dummy light Ld of the wavelength λt and the span loss, each measured value of OSNR is likely to match the new OSNR indicator value 94. Therefore, the second quality estimator 127 estimates a corresponding value 94X on the new OSNR indicator value 94 corresponding to the wavelength λ1 as the second estimated value of the OSNR of the signal light L1.

Furthermore, the second quality estimator 127 calculates a third estimated value of the OSNR of the signal light L1 that cannot be estimated based on the dummy light Ld having the wavelengths λs and λt, based on the following formula (2). NF is an example of a specification value of the optical amplifier, and specifically corresponds to a noise figure of the optical amplifier 45.

$$OSNR ( the third estimated value ) = the fifth measured value - NF - constant \qquad Formula ( 2 )$$

The above-described constant is uniquely determined for each signal band by the product (h×v×Δf) of the Planck constant h, the optical frequency v, and the reception bandwidth Δf. For example, if the center frequency of the C band is “193. 625 (THz)” (center wavelength is “1548. 3 (nm)”), a unique constant “−57. 9 (dB)” is determined. If the center frequency of the L-band is “188. 5 (THz)” (center wavelength is “1590. 4 (nm)”), a unique constant “−58. 1 (dB)” is determined.

When the second quality estimator 127 estimates the first and second estimated values of the OSNR of the signal light L1, calculates the third estimated value, the second quality estimator 127 sums the first and second estimated values and the third estimated valus based on the following Formula (3) to estimate the overall OSNR of the signal light L1 having the wavelength λ1.

$$1 / OSNR ( overall ) = \{ 1 / OSNR ( the first estimated value ) \} + \{ 1 / OSNR ( the second estimated value ) \} + \{ 1 / OSNR ( the third estimated value ) \} \qquad Formula ( 3 )$$

Thus, even in the case #3, the ROADM 40G can estimate the overall OSNR of the signal light L1 having the wavelength λ1. In the case where the measured values of the OSNRs do not match the new OSNR indicator value 93 or do not match the new OSNR indicator value 94, the second quality estimator 127 can apply the amount of deviation described in the case #1.

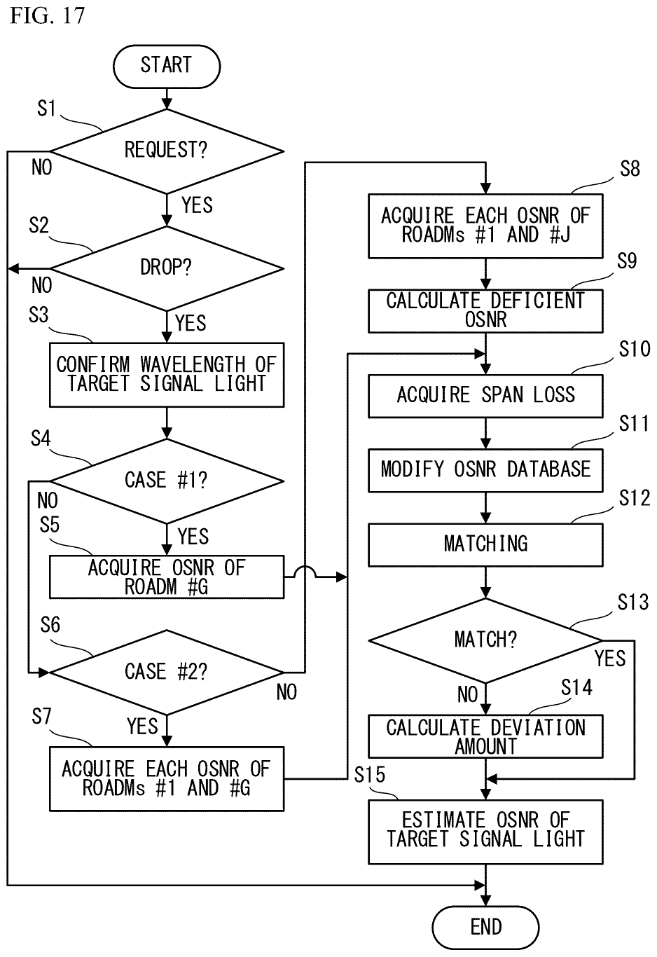

Referring to FIG. 17, an example of the operation of the ROADM 40G will be described. The ROADMs 40S, 40X, 40Y and 40J are basically similar to the ROADM 40G, and therefore, detailed description thereof is omitted.

First, the second quality notifier 128 determines whether or not notification of the OSNR of the signal light L1 is requested (step S1). For example, the second quality notifier 128 determines whether or not the notification of the OSNR of the signal light L1 is requested from the business operator terminal of the business operator operating the optical network NW through the NMS 80 during the actual operation of the optical network NW.

When the notification of the OSNR of the signal light L1 is not requested (step S1: NO), the second quality notifier 128 ends a processing. When the notification of the OSNR of the signal light L1 is requested (step S1: YES), the second quality estimator 127 determines whether or not the signal light L1 is dropped (step S2). For example, the second quality estimator 127 acquires and confirms the pre-wavelength data and the post-wavelength data managed by the NMS 80, thereby determining whether or not the signal light L1 is branched.

When there is no branch of the signal light L1 (step S2: NO), the second quality estimator 127 ends the processing. When the signal light L1 is branched (step S2: YES), the second quality estimator 127 confirms the wavelength of the target signal light (step S3). In the present embodiment, the second quality estimator 127 confirms the wavelength λ1 of the signal light L1 as the target signal light.

When the wavelength of the target signal light is confirmed, the second quality estimator 127 determines whether the case #1 is satisfied (step S4). The second quality estimator 127 can determine whether the case corresponds to the case #1 or not by acquiring and confirming the pre-wavelength data and the post-wavelength data managed by the NMS 80. If the case corresponds to the case #1 (step S4: YES), the second quality estimator 127 acquires the OSNR measured by the ROADM #G (step S5). That is, the second quality estimator 127 acquires the measured values of the OSNR of the wavelengths λp1, . . . , λp5 measured by the ROADM 40G.

If the case does not correspond to the case #1 (step S4: NO), the second quality estimator 127 determines whether the case corresponds to the case #2 (step S6). The second quality estimator 127 can determine whether the case corresponds to the case #2 or not by confirming the pre-wavelength data and the post-wavelength data. If the case corresponds to the case #2 (step S6: YES), the second quality estimator 127 acquires the respective OSNRs measured by the ROADM #1 and the ROADM #G (step S7). That is, the second quality estimator 127 acquires the measured values of the respective OSNRs of the wavelengths λq1, . . . , λq5 measured by the ROADM 40X and the measured values of the respective OSNRs of the wavelengths λr1, . . . , λr5 measured by the ROADM 40G.

When the case does not correspond to the case #2 (step S6: NO), the second quality estimator 127 acquires the respective OSNRs measured by the ROADM #1 and the ROADM #J (step S8). That is, when the case does not correspond to the case #2, the second quality estimator 127 determines that the case corresponds to the case #3. In this case, the second quality estimator 127 acquires the measured values of the respective OSNRs of the wavelengths λs1, . . . , λs5 measured by the ROADM 40X and the measured values of the respective OSNRs of the wavelengths λt1, . . . , λt5 measured by the ROADM 40J.

After acquiring the respective OSNRs measured by the ROADM #1 and the ROADM #J, the second quality estimator 127 calculates the deficient OSNR (step S9). That is, the second quality estimator 127 calculates the third estimated value of the OSNR of the signal light L1 as the deficient OSNR.

When any of the processing of steps S5, S7, and S9 is ended according to the case #1, the case #2, and the case #3, the second quality estimator 127 acquires the span loss (step S10). More specifically, the second quality estimator 127 acquires a measured value of the span loss managed as the measured data by the NMS 80. The second quality estimator 127 may acquire the measured value of the span loss from the measured value storage 113.

When the span loss is acquired, the second quality estimator 127 modifies the OSNR database (step S11). Specifically, the second quality estimator 127 modifies at least one of the first OSNR indicator value 85, the second OSNR indicator value 86, and the third OSNR indicator value 87 recorded in the OSNR database based on the acquired measured value of the span loss.

After the OSNR database is modified, the second quality estimator 127 performs matching (step S12) and determines whether or not the values match (step S13). That is, the second quality estimator 127 matches the measured value of each OSNR of the dummy light Ld with the new OSNR indicator value included in the modified OSNR database, and determines whether or not they match.

When the measured value of each OSNR of the dummy light Ld matches the new OSNR indicator value included in the modified OSNR database (step S13: YES), the second quality estimator 127 estimates the OSNR of the target signal light (step S15). That is, the second quality estimator 127 estimates the OSNR of the signal light L1 as the target signal light based on each of the estimation methods of the case #1, the case #2, and the case #3.

When the measured value of each OSNR of the dummy light Ld do not match the new OSNR indicator value included in the modified OSNR database (step S13: NO), the second quality estimator 127 calculates the amount of divergence between the measured value of each OSNR of the dummy light Ld and the new OSNR indicator value included in the modified OSNR database (step S14), and estimates the OSNR of the signal light L1 on the basis of the amount of divergence. After estimating the OSNR of the signal light L1, the second quality estimator 127 notifies the estimated value of the OSNR of the signal light L1 to the business operator terminal that has requested the notification of the OSNR of the signal light L1, and ends the processing.

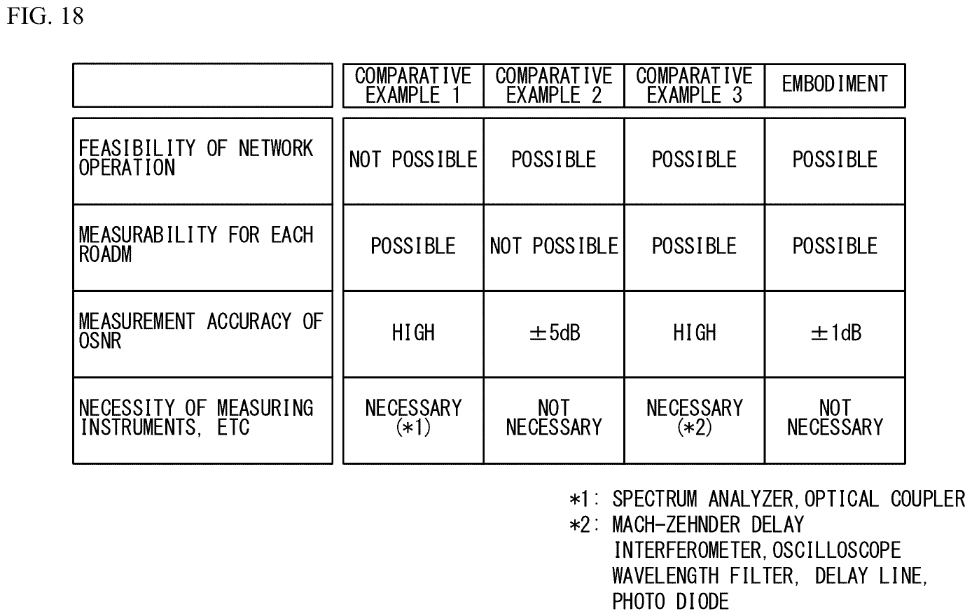

Referring to FIG. 18, the effect of the present invention will be described in comparison with three comparative examples.

In the first comparative example, the OSNR of the signal light L1 is actually measured by using a spectrum analyzer and an optical coupler. In this case, the OSNR of the signal light L1 cannot be measured during the actual operation of the optical network NW. For example, the ROADM 40G is required to be equipped with a measuring instrument such as the spectrum analyzer, and the manufacturing cost of the ROADM 40G may increase.

In the second comparative example, the OSNR of the signal light L1 is measured by using transponders 10, 20. In this case, the OSNR of the signal light L1 cannot be measured in each of the ROADMs 40S, 40X, 40Y, 40J, and 40G. In addition, measurement accuracy of the OSNR of the signal light L1 is about ±5 dB, and the measurement accuracy is not as high as that of the embodiment described later.

In the comparative example 3 (for example, Japanese Patent Application Publication No. 2015-39180), the OSNR of the signal light L1 is measured by using a Mach-Zehnder delay interferometer, an oscilloscope, or the like. In this case, the ROADM 40G is required to be equipped with the measuring instrument such as the Mach-Zehnder delay interferometer, and the manufacturing cost of the ROADM 40G may increase.

In contrast, in the embodiment, the OSNR of the signal light L1 is measured during the actual operation of the optical network NW. Further, for example, the ROADM 40G does not need to be equipped with the measuring instrument such as the spectrum analyzer or the Mach-Zehnder delay interferometer. Furthermore, the OSNR of the signal light L1 can be measured by each of the ROADMs 40S, 40X, 40Y, 40J, and 40G, and the measurement accuracy is also about ±1 dB, which is improved as compared with the comparative example 2.

Although the preferred embodiments of the present invention have been described above in detail, the present invention is not limited to the specific embodiments, and various modifications and changes are possible within the scope of the gist of the present invention described in the claims.

For example, at least one of the span loss measurer 123, the input optical power measurer 124, the first quality measurer 125 and the second quality estimator 127 may be provided in the NMS 80. Various measured values may be transmitted and received by the OSC lights Lo1 and LO2 without the NMS 80. Furthermore, for example, in the case #2, the dummy light Ld of the wavelength λq and the signal light L3 of the wavelength λq may not be transmitted, and the signal lights L1 and L2 of the wavelength λ1 and the signal light L3 of the wavelength λr may be transmitted.

What is claimed is:

1. An optical transmission system comprising:
a first optical transmission device that transmits a first signal light in an actual operation and a first pseudo light having a wavelength different from that of the first signal light;
a second optical transmission device that receives the first signal light and the first pseudo light from the first optical transmission device;
a measurer that measures a first quality of the first pseudo light between the first optical transmission device and the second optical transmission device; and
an estimator that estimates a second quality of the first signal light between the first optical transmission device and the second optical transmission device based on the first quality and an indicator value of wavelength dependence in a signal band.

2. The optical transmission system according to claim 1, wherein
the second optical transmission device has an optical channel monitor,
the first optical transmission device switches between emission of the first pseudo light and emission stop of the first pseudo light, and
the measurer measures the first quality based on a first measurement value by the optical channel monitor at the time of the emission and a second measurement value by the optical channel monitor at the time of the emission stop.

3. The optical transmission system according to claim 1, wherein
the first quality and the second quality are an optical signal-to-noise ratio.

4. The optical transmission system according to claim 1, wherein
the indicator value indicates a correspondence relationship between a plurality of wavelengths and at least the first quality, the plurality of wavelengths including a wavelength of the first signal light and a wavelength of the first pseudo light.

5. The optical transmission system according to claim 1, wherein
the indicator value is measured before an operation of an optical communication service performed between the first optical transmission device and the second optical transmission device based on the first signal light is started.

6. The optical transmission system according to claim 1, further comprising:
a third optical transmission device that receives the first pseudo light from the first optical transmission device, switches a received first pseudo light to a second pseudo light having a wavelength different from that of the first pseudo light, and transmits the second pseudo light to the second optical transmission device,
wherein the measurer measures a third quality of the first pseudo light between the first optical transmission device and the third optical transmission device and a fourth quality of the second pseudo light between the third optical transmission device and the second optical transmission device, and
wherein the estimator estimates the second quality based on the third quality, the fourth quality, and the indicator value.

7. The optical transmission system according to claim 1, further comprising:
a third optical transmission device that receives the first pseudo light from the first optical transmission device, switches a received first pseudo light to a second signal light having any wavelength belonging to a wavelength of the first pseudo light, and transmits the second signal light to the second optical transmission device,
wherein the measurer measures a third quality of the first pseudo light between the first optical transmission device and the third optical transmission device, and
wherein the estimator estimates the second quality based on the third quality and the indicator value.

8. The optical transmission system according to claim 7, wherein
the measurer further measures a span loss of the first pseudo light between the first optical transmission device and the second optical transmission device, and
the estimator estimates the second quality based on at least one of the first quality, the span loss, the indicator value, and an input optical power of a second signal light having a wavelength belonging to a wavelength of the first pseudo light to the second optical transmission device.

9. The optical transmission system according to claim 7, wherein
the measurer calculates a fifth quality of the second signal light between the third optical transmission device and the second optical transmission device based on an input optical power of the second signal light to the second optical transmission device and a specification value of an optical amplifier provided in the second optical transmission device, and
the estimator estimates the second quality based on the third quality, the fifth quality, and the indicator value.

10. The optical transmission system according to claim 1, wherein
the measurer or the estimator is provided in at least one of the first optical transmission device, the second optical transmission device, a third optical transmission device positioned between the first optical transmission device and the second optical transmission device, and a controller that controls operations of the first optical transmission device, the second optical transmission device, and the third optical transmission device.

11. The optical transmission system according to claim 1, wherein
the measurer further measures a span loss of the first pseudo light between the first optical transmission device and the second optical transmission device, modifies the indicator value based on the span loss, and calculates a deviation amount between the first quality and the modified indicator value; and
the estimator estimates the second quality based on the amount of deviation.

12. An optical transmission system comprising:
a first optical transmission device that transmits a first signal light and a second signal light of different wavelengths, both of the first signal light and the second signal light being in actual operation;
a second optical transmission device that receives the first signal light and the second signal light, and transmits the first signal light and a first pseudo light having a plurality of wavelengths including the wavelength of the second signal light;
a third optical transmission device that receives the first signal light and the first pseudo light from the second optical transmission device;
a measurer that measures a first quality of the first pseudo light between the second optical transmission device and the third optical transmission device; and
an estimator that estimates a second quality of the first signal light between the first optical transmission device and the third optical transmission device based on the first quality and an indicator value of wavelength dependence in a signal band.

13. A quality estimation method comprising:
estimating a signal quality of a first signal light between a first optical transmission device that transmits a first signal light in actual operation and a first pseudo light having a wavelength different from that of the first signal light and a second optical transmission device that receives the first signal light and the first pseudo light from the first optical transmission device; and
estimating a second quality representing a signal quality of the first signal light between the first optical transmission device and the second optical transmission device based on a first quality representing a signal quality based on measurement of the first pseudo light between the first optical transmission device and the second optical transmission device and an indicator value of wavelength dependence in a signal band.
